(19) United States
(12) Patent Application Publication
(10) Pub. No.: US 2006/0124567 A1
(43) Pub. Date: Jun. 15, 2006

(54) Perfect cook Shish-Ka-Bob rack and skewer device

(76) Inventors: James Anthony Bove, Bolivia, NC (US); Luther Rice Gilliam, Little River, SC (US)

Correspondence Address: James A. Bove, 3335 Sugar Sand Drive SE, Bolivia, NC, 28422, US

(21) Appl. No.: 10/941,676

(22) Filed: Dec. 13, 2004

(51) Int. Cl. B42F 13/12

(52) U.S. Cl. 211/125; 211/175

(57) ABSTRACT

A shish-ka-bob device for cooking food items over any outdoor grill or under an oven broiler. The rack or holding apparatus includes vertical supports that can be placed on top of a grill or under a broiler resting on a broiler pan. Removable skewers are provided each having an elongated shape with a large flat tab handle area on the proximal end. The distal ends of the skewers are pointed and sharp permitting food to be pierced and placed in a stacking position the length of the skewer area. The skewers are then placed in the slots of the rack for grilling or oven broiler cooking. When the tab end of the skewer is rotated a quarter turn the tab handle will either be in a vertical position inserted in the appropriate slot or the tab will lye flat on the top of the support rack. These two positions will alternate as the cook completes the 360 degree cycle to cook all sides of the shish ka bob.

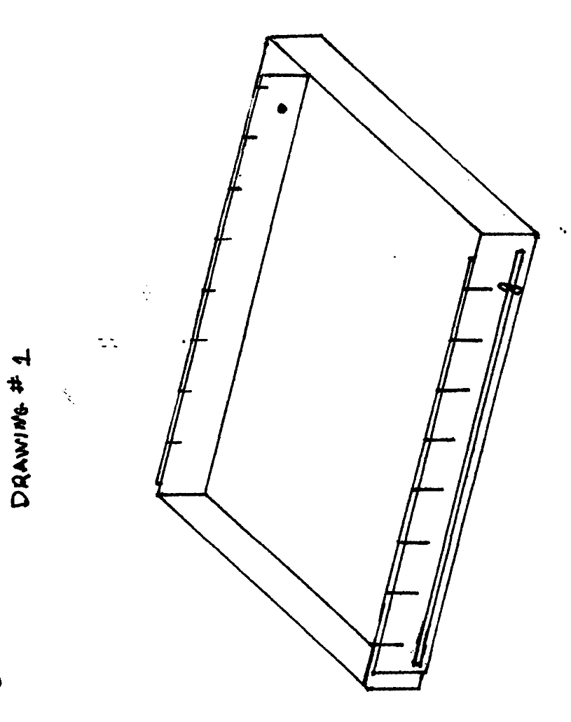

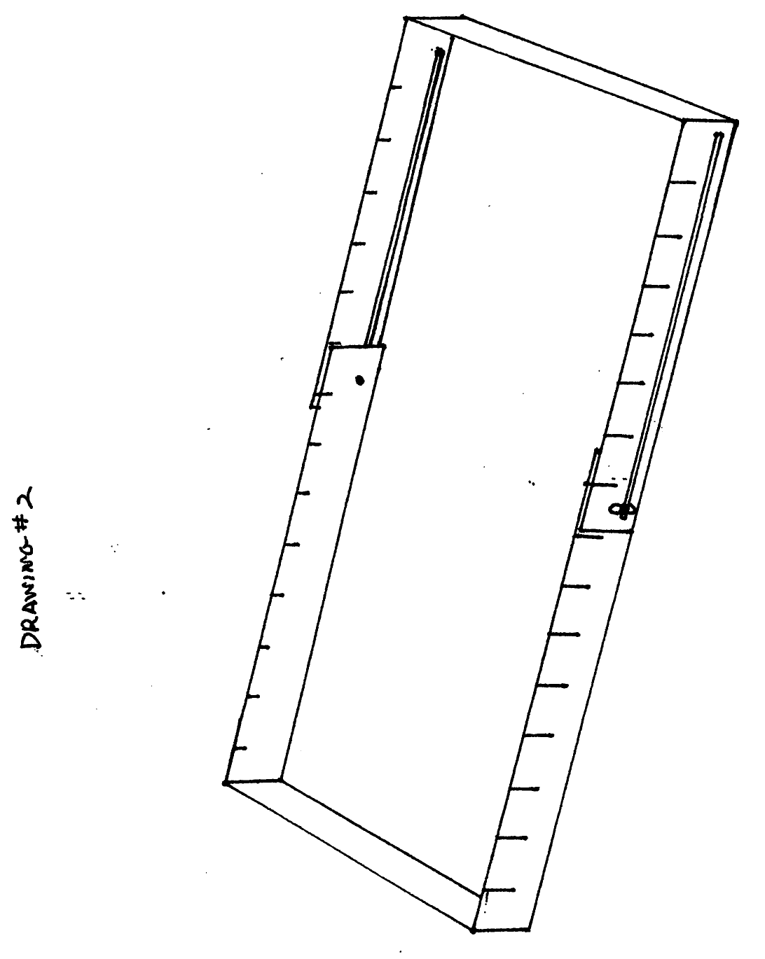

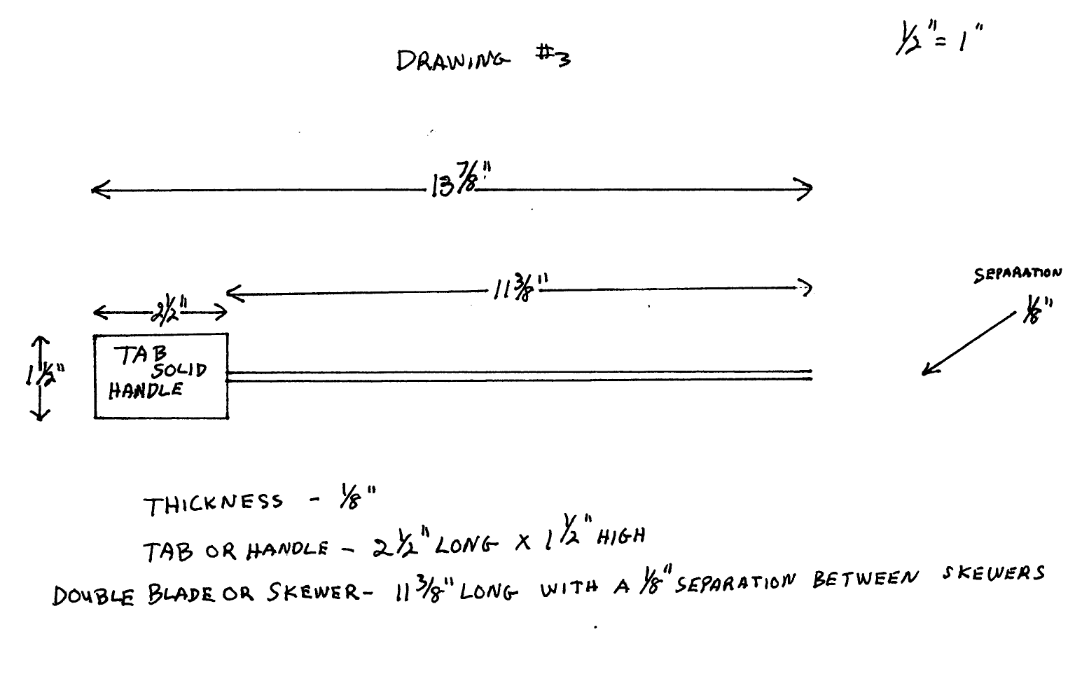

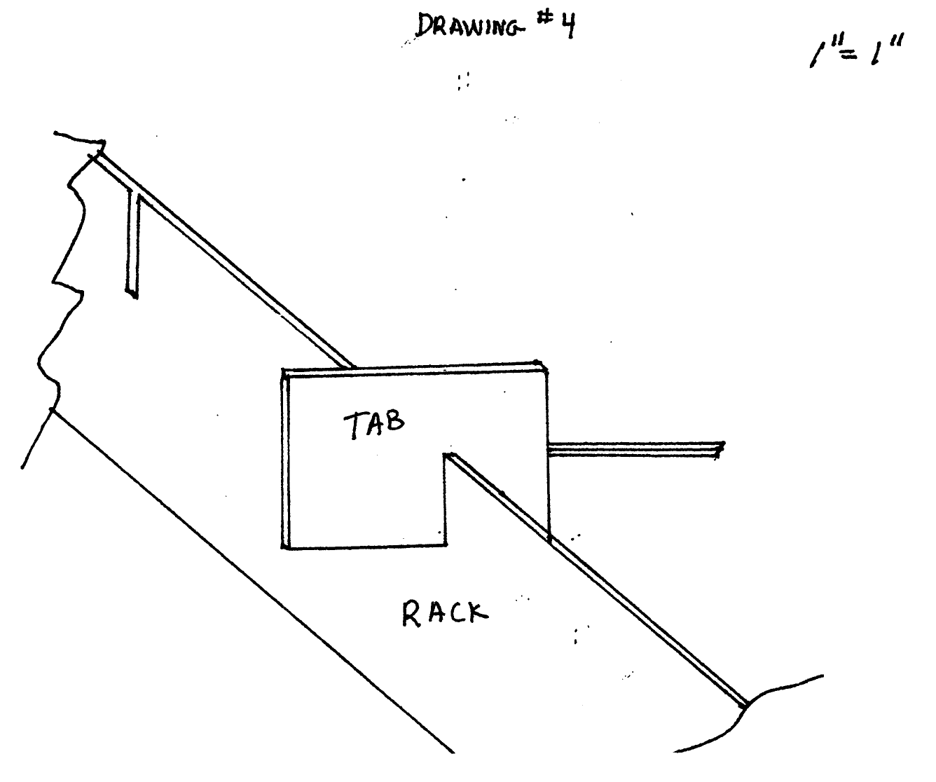

### FIELD OF THE INVENTION

This invention is a device that permits cooking of small pieces of food placed on movable skewers that can be placed over a hot fire.

### BACKGROUND

Shish-ka-bobs are generally small pieces of food including meats, fish, shrimp and assorted vegetables that are impaled on a skewer and then placed over a charcoal fire or grill to cook.

These cooking devices enable the small pieces of food to be placed on a skewer and then positioned over a grill or fire to cook them. The general idea is to gradually cook each side and rotate the skewers periodically so that all of the food cooks evenly without burning. This is not always easy do to the fact that often times the skewers involuntarily roll over or refuse to stay in a position to cook evenly.

The purpose of this invention is to provide a rack and skewer combination that will permit the cooking of shish-ka-bob style foods on a device that ensures that the food placed over a charcoal fire will cook evenly every time with a minimal effort on the part of the cook.

### SUMMARY OF THE INVENTION

The Perfect Cook Shish-Ka-Bob rack and Skewer system was designed to ensure that each and every time the device is used it will provide the cook with the ability to regulate the exposure to heat and temperature for each individual skewer. It will accomplish this with a complete control over the stabilization of the skewers while cooking.

### BRIEF DESCRIPTION OF THE DRAWINGS

Drawing #1 depicts the shish-ka-bob rack in the closed position.

Drawing #2 depicts the shish-ka-bob rack in the fully extended position.

Drawing #3 depicts the side view of a skewer.

Drawing #4 depicts a skewer tab resting in the large slot of the shish-ka-bob rack.

### DETAILED DESCRIPTION OF THE DRAWINGS

Drawing #1 depicts the Shish-Ka-Bob rack composed of two U shaped pieces of metal bent at the corners to 90 degrees. The outer section has a slot running the length of both sides to allow the bolt portion of the inner rack to slide inside the slot of the outer rack which enables the user to adjust the rack to the desired width simply by loosening and tightening the wing nut and positioning the slots so they overlap at the desired width. In the fully closed position the rack will accommodate eight skewers. In this position the rack is two inches tall and eleven inches deep and is eighteen and three eighth inches wide.

Drawing #2 depicts the Shish-Ka-Bob rack in its fully extended position. Again the rack is two inches tall and is eleven inches deep. The width fully extended measures thirty-two and three eighths wide. In this position the rack can accommodate fifteen skewers.

Drawing #3 depicts one of the skewers designed for use in the Perfect Cook Shish-Ka-Bob Rack. The skewer's overall length is thirteen and seven-eighths inches long and one eighth inch thick made of metal. There are actually double skewer projections each measuring eleven and three-eights long with a one eighth inch separation between the twin skewers. These are connected to the tab handle on the one and one-half inch side of the tab. The tab portion of the skewer measures two and one-half inches long and one and one-half inches tall and one-eighth inches thick.

Drawing #4 depicts the tab portion of the skewer resting on the slot of the rack in full scale.
Material; Metal rack and metal skewers made from ⅛″ thick material.
Rack Dimensions: Length: 11″ inches, Width: adjustable from 18⅜″ inches with 8 skewer slots to 32⅜″ inches expanding to 15 skewer slots, Height: 2″ inches.
Rack Slot Dimensions: Front slots are ⅞″ inches deep by 3/16″ wide, rear slots are ¼″ deep by 3/16″ wide.
How Rack Is Adjusted: There is a slot in the outer rack 15¼″ long by ¼″ wide that is positioned ⅜″ from the bottom of the rack. The inner rack has a ¼″ threaded bolt located centered ½″ inch up from the bottom of the rack and ⅝″ inch from the end of the rack with a wing nut that can be loosened allowing the racks to slide together or apart to adjust to the desired grilling width.
Skewer Dimensions: Overall length 13⅞″ inches Twin Skewer blades each are 11⅜″ inches long with an ⅛″ space between skewer blades. Both are connected to the 1½″ side of the tab handle. Tab handle length 2½″ inches long by 1½″ inches tall by ⅛″ thick

### BENEFITS AND OPERATION OF PERFECT COOK SHISH-KA-BOB RACK

Step One: After you have skewered the meat and other food items that you wish to grill on the barbeque place the tip of the skewer into the short slot on the back side of the rack, then place the tab end of the skewer vertically into the deep slot opposite the short slot that is holding the tip of the skewer. This is position one. Let the food cook several minutes on this side. Repeat for all skewers.

Step Two: Lift the tab end of the skewer from the deep slot and rotate it clockwise a ¼ turn and then lay the tab flat centered over the deep slot. This is position two. Again let the food cook several minutes. Repeat for all skewers.

Step Three: Lift the tab end of the skewer and rotate the tab a ¼ turn and then insert the tab vertically into the deep slot. This is position three. Again let the food cook several minutes. Repeat for all skewers.

Step Four: Lift the tab end of the skewer and rotate the tab clockwise a ¼ turn and then lay the tab flat centered over the deep slot. This is position four. Again let the food cook for several minutes. Repeat for all skewers.

### BENEFITS

THE RACK HOLDS THE SKEWERS FIRMLY IN A FIXED POSITION ALLOWING THE FOOD TO BE COOKED EVENLY WITHOUT HAVING TO CONSTANTLY ADJUST OF REARRANGE THE SKEWERS TO PROP THEM UP IN A POSITION TRYING TO PREVENT BURNING ONE SIDE OF THE FOOD. THE RESULT IS SHISH-KA-BOB THAT IS COOKED EVENLY AND EXACTLY THE WAY YOU WISHED IT TO BE COOKED EACH AND EVERY TIME.

Dimensions of Rack in the Closed Position:

18⅜″ Wide×11″ Deep×2″ High

Dimensions of Rack in the Fully Opened Position:

32⅜″ Wide×11″ Deep×2″ High

Dimensions of each Portion of Rack Halves:

Inner Rack Closed End 10¾″ Deep And Each Leg 17″ Long By 2″ Tall

Outer Rack Closed End 11″ Deep And Each Leg 17″ Long By 2″ Tall

Depth of Skewer Slots in Racks:

Front Skewer Slots ⅞″ Deep× 3/16″ Wide, Rear Skewer Slots ¼″

Deep× 3/16″ Wide, All Slots Both Front And Rear Are Spaced 2″ Apart

Slots for Adjusting Bolts in the Outer Rack:

Slot Length 15¼″×¼″ Wide Located ⅜″ From Rack Bottom And From Rack Ends. Inner Rack Has A ¼″ Threaded Bolt Located Centered ½″ From The Bottom Of The Rack And ⅝″ From The End Of The Rack Fastened With A Wing Nut.

The Skewer Dimensions:

13¾″ Long×⅛″ Thick

2⅛″ Square Skewer Projections ⅛″ Apart 11⅜″ Long Connected To The Center Of The Rectangular Tab Skewer Handle On The 1½″ Side Of The Tab, Which Is 1½″ Tall And 2½″ Long And ⅛″ Thick.

What is claimed is:

1. A device for positioning multiple skewered ka-bobs over an open flame during a cooking process that will maintain a skewer in a selected cooking position comprising:
a supporting rack consisting of two halves with one rack being slightly smaller in width enabling it to fits snugly within the outer rack;
the racks are joined utilizing the bolt and wing nut, the rack can now be adjusted to accommodate the desired number of skewers;
the notched slots hold the inserted skewers firmly in place by means of the flat rectangular tab handle on the one end;
the tab when inserted vertically in the front slots of the rack hold the skewers in perfect position;
the tab can also be placed flat across the top edge of the support rack providing a second position that will not permit the skewer to involuntarily shift or rotate;
each skewer has twin projecting tines that permit food morsels to be placed on to the skewer tines simultaneously preventing the morsels from rotating involuntarily on the skewer;
